(19) United States
(12) Patent Application Publication
(10) Pub. No.: US 2011/0219301 A1
(43) Pub. Date: Sep. 8, 2011

(54) IMAGE FORMING APPARATUS, PREVIEW DISPLAY METHOD THEREFOR, AND RECORDING MEDIUM

(75) Inventors: Kazuaki Tomono, Itami-shi (JP); Kenichi Takahashi, Osaka (JP); Takeshi Minami, Amagasaki-shi (JP); Daisuke Sakiyama, Kawanishi-shi (JP); Yosuke Taniguchi, Osaka-shi (JP)

(73) Assignee: Konica Minolta Business Technologies, Inc., Tokyo (JP)

(21) Appl. No.: 13/030,604

(22) Filed: Feb. 18, 2011

(30) Foreign Application Priority Data
Mar. 2, 2010 (JP) 2010-045875

(51) Int. Cl. G06F 17/00

(52) U.S. Cl. 715/274

(57) ABSTRACT

An image forming apparatus includes: an information taker that obtains information of a key selection screen previously customized on the image forming apparatus itself or information of a key selection screen customized on a different image forming apparatus; and a comparison portion that compares second features currently installed on the image forming apparatus to first features installed on the image forming apparatus originally before the customization or to first features installed on the different image forming apparatus. And if it is judged based on the comparison results that the second features include one or more than one feature of the print function, not included in the first features, a controller makes a display portion indicates that there is a new feature having been installed on the image forming apparatus while displaying a preview image of print data to be outputted.

This application claims priority under 35 U.S.C. §119 to Japanese Patent Application No. 2010-045875 filed on Mar. 2, 2010, the entire disclosure of which is incorporated herein by reference in its entirety.

### BACKGROUND OF THE INVENTION

1. Technical Field

The present invention relates to: an image forming apparatus that can be customized so that one or more than one operation key to enable a feature installed on the image forming apparatus itself will not appear on a key selection screen on a display of an operation panel for example, and displays a preview image of print data on the display; a preview display method for the image forming apparatus; and a computer-readable recording medium having a preview display program stored thereon to make a computer of the image forming apparatus implement the preview display method.

2. Background Technology

The following description sets forth the inventor's knowledge of related art and problems therein and should not be construed as an admission of knowledge in the prior art.

The image forming apparatuses of recent years, for example multifunctional digital machines that are also called MFPs (Multi Function Peripherals), have gotten a lot of features. Such an image forming apparatus displays a key selection screen with operation keys to enable those features, in the upper region of a screen on an operation panel, so that users can select a preferable one among the keys to set an operation mode of the image forming apparatus.

Many users tend to use only basic ones among the features installed on the image forming apparatus, or they unconsciously use some fixed ones among those, depending on their environment using the image forming apparatus and their jobs there. However, with too many operation keys, including necessary and unnecessary ones being in a mixed manner on a screen of the operation panel, it is quite troublesome to differentiate one from another and perform more operations to complete setting a target feature.

To resolve this inconvenience, there is a technology called “my-panel function”, serving any users with different characteristics of use, and allowing administration-level users or the like to customize a key selection screen so as to hide unnecessary operation keys depending on their environment using the image forming apparatus.

Furthermore, information of a customized key selection screen is kept stored on the image forming apparatus, and when this information is ported to a different image forming apparatus, users will be able to use the customized key selection screen on the different image forming apparatus without performing customization all over again. The information of a customized key selection screen may be ported again to the image forming apparatus after a new feature is installed on the image forming apparatus.

As disclosed in Japanese Patent Publication No. 2003-320740, there is an image processing apparatus capable of displaying a preview image of print information, and this image processing apparatus can display information of a finishing setting on a preview screen so as to allow users to change the finishing setting.

Also, as disclosed in Japanese Patent Publication No. 2004-056658, there is an information processing system allowing users to visually check a print image to be outputted from a receiver machine, in an easy manner, when trying to transmit data via facsimile.

In this image processing system, when porting information of a customized key selection screen from a first image forming apparatus to a second image forming apparatus having a feature that the first image forming apparatus doesn't have, this second image forming apparatus will not display an operation key to enable this feature on the customized key selection screen. So, no matter how advanced and useful this feature is, users will use the second image forming apparatus even without knowing the presence of this feature, which is very inconvenient.

More specifically, if this feature is related to the print function that users most frequently use, they will feel more inconveniences due to the great opportunity loss.

Meanwhile, when the information of a customized key selection screen is ported again to the first image forming apparatus after a new feature of the print function is installed thereon, users will use the first image forming apparatus even without knowing the presence of this new feature, which is also inconvenient.

The technologies in the Patent Documents described above didn't provide an effective solution to these inconveniences.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image forming apparatus that, when information of a customized key selection screen is ported to the image forming apparatus itself or to a different image forming apparatus, allows users to know quite easily if a new feature of the print function has been installed on either of the image forming apparatuses after the key selection screen was customized.

It is another object of the present invention to provide a preview display method for the image forming apparatus.

It is yet another object of the present invention to provide a computer-readable recording medium having a preview display program stored thereon to make a computer of the image forming apparatus implement the preview display method.

According to a first aspect of the present invention, an image forming apparatus includes:
a display portion that displays a key selection screen with one or more than one first operation key to enable a feature of the image forming apparatus, being thereon;
a customization portion that is capable of customizing the key selection screen according to a user operation so that at least one of the first operation keys will not appear thereon;
an information taker that obtains information of a key selection screen customized on a different image forming apparatus or information of another key selection screen previously customized by the customization portion of the image forming apparatus;
a controller that makes the display portion display the customized key selection screen according to the information obtained by the information taker; and
a comparison portion that compares second features currently installed on the image forming apparatus to first features installed on the image forming apparatus originally before the customization or to first features installed on the different image forming apparatus,
and wherein if it is judged based on the comparison results that the second features include one or more than one feature of the print function, not included in the first features, the controller makes the display portion allow users to know that there is a new feature having been installed on the image forming apparatus while displaying a preview image of print data to be outputted.

According to a second aspect of the present invention, a preview-displaying method for an image forming apparatus, includes:
customizing a key selection screen with one or more than one operation key to enable a feature of the image forming apparatus, being thereon, according to a user operation, by changing information of the key selection screen so that at least one of the operation keys will not appear thereon;
obtaining information of a key selection screen customized on a different image forming apparatus or information of another key selection screen previously customized on the image forming apparatus;
making a display portion display the customized key selection screen according to the obtained information; and
comparing second features currently installed on the image forming apparatus to first features installed on the image forming apparatus originally before the customization or to first features installed on the different image forming apparatus,
and wherein if it is judged based on the comparison results that the second features include one or more than one feature of the print function, not included in the first features, the display portion allows users to know that there is a new feature having been installed on the image forming apparatus while displaying a preview image of print data to be outputted.

According to a third aspect of the present invention, a computer-readable recording medium has a preview display program stored thereon to make a computer of an image forming apparatus execute:
customizing a key selection screen with one or more than one operation key to enable a feature of the image forming apparatus, being thereon, according to a user operation, by changing information of the key selection screen so that at least one of the operation keys will not appear thereon;
obtaining information of a key selection screen customized on a different image forming apparatus or information of another key selection screen previously customized on the image forming apparatus;
making a display portion display the customized key selection screen according to the obtained information; and
comparing second features currently installed on the image forming apparatus to first features installed on the image forming apparatus originally before the customization or to first features installed on the different image forming apparatus,
and wherein if it is judged based on the comparison results that the second features include one or more than one feature of the print function, not included in the first features, the display portion allows users to know that there is a new feature having been installed on the image forming apparatus while displaying a preview image of print data to be outputted.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view illustrating a configuration of an image forming system according to one mode of embodied implementation of the present invention;

FIG. 2 is a block diagram illustrating a configuration of a server employed in the image forming system of FIG. 1;

FIG. 3 is a block diagram illustrating a configuration of an image forming apparatus employed in the image forming system of FIG. 1;

FIG. 4A is a view illustrating a basic setting screen for setting the print function and its lower-class key selection screen displayed on a panel display of an image forming apparatus 2. FIG. 4B is a view illustrating a basic setting screen for setting the print function and its lower-class key selection screen displayed on a panel display of an image forming apparatus 3;

FIG. 5A is a view illustrating an applied setting screen for setting the print function and its lower-class key selection screen displayed on the panel display of the image forming apparatus 2. FIG. 5B is a view illustrating an applied setting screen for setting the print function and its lower-class key selection screen displayed on the panel display of the image forming apparatus 3;

FIG. 6A is a view illustrating an example of a my-panel that is a customized screen without a predetermined operation key being thereon, displayed on the panel display of the image forming apparatus 2. FIG. 6B is a view illustrating a basic setting screen that is displayed on the panel display of the image forming apparatus 3 after obtaining my-panel information to reproduce the my-panel illustrated as FIG. 6A;

FIG. 7A is a view illustrating an example of a my-panel that is a customized applied setting screen without a predetermined operation key being thereon, displayed on the panel display of the image forming apparatus 2. FIG. 7B is a view illustrating an applied setting screen that is displayed on the panel display of the image forming apparatus 3 after obtaining my-panel information to reproduce the my-panel illustrated as FIG. 7A;

FIG. 8, relating to another embodiment of the present invention, is a view illustrating a screen with a preview image of print data;

FIG. 9 is a view illustrating a screen to be displayed next when pressing a “Check New Item” key via the screen of FIG. 8;

FIG. 10 is a view illustrating a screen to be displayed next when pressing a “Color” key via the screen of FIG. 9;

FIG. 11 is a view illustrating a screen to displayed next when pressing a “Color” key via the screen of FIG. 10;

FIG. 12 is a view illustrating a table of installed feature information of the image forming apparatus 2;

FIG. 13 is a view illustrating a table of installed feature information of the image forming apparatus 3;

FIG. 14 is a view illustrating a table of my-panel information stored on the image forming apparatus 2;

FIG. 15 is a view illustrating a table of new feature information;

FIG. 16 is a flowchart to describe a processing routine to display a key selection screen on the panel display of the image forming apparatus 3;

FIG. 17 is a flowchart representing a sub routine to make a table of my-panel information, which corresponds to Step S03 of FIG. 16;

FIG. 18 is a flowchart representing a sub routine to obtain a table of my-panel information, which corresponds to Step S04 of FIG. 16;

FIG. 19 is a flowchart representing a sub routine to make a table of installed feature information, which corresponds to Step S06 of FIG. 16;

FIG. 20 is a flowchart representing a sub routine to make a table of new feature information, which corresponds to Step S07 of FIG. 16;

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one of the best modes of implementing the present invention will be described with reference to the accompanying drawings.

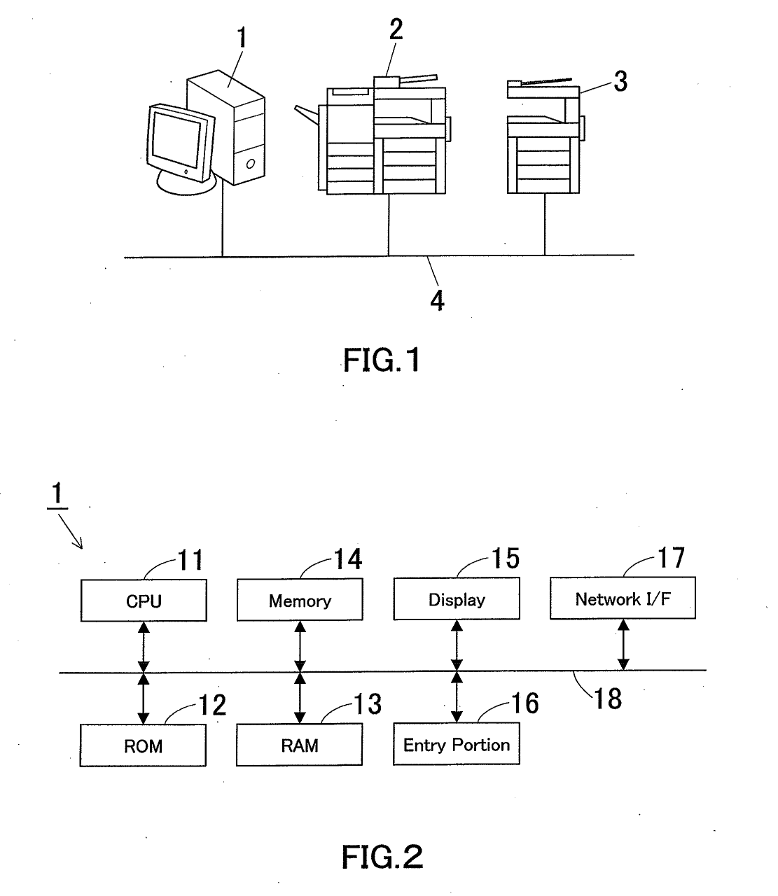

FIG. 1 is a view illustrating a configuration of an image forming system, in which an image forming apparatus according to one mode of embodied implementation of the present invention is employed. This image forming system includes a server 1, and image forming apparatus 2 and 3 as an example of a plurality of image forming apparatuses, connected to each other via a network 4.

The server 1 is, for example, a personal computer. Specifically in this mode of embodied implementation, it stores information of a large number of key selection screens customized for every user on the image forming apparatuses 2 and 3, information of features installed on the image forming apparatuses 2 and 3, and other information.

In this Specification, it should be understood that a key selection screen customized for a user is referred to as “my-panel”, and information of a my-panel is referred to as “my-panel information”.

FIG. 2 is a block diagram illustrating a configuration of the server 1.

The server 1 includes a CPU 11, a ROM 12, a RAM 13, a memory 14, a display 15, an entry portion 16, and a network interface (network I/F) 17, and these portions are connected to each other via a system bus 18.

The CPU 11 integrally controls the entire server 1 by executing a program stored on a memory such as the ROM 12. More specifically, in this mode of embodied implementation, for example, it stores information of my-panels received from the image forming apparatuses 2 and 3 and information of features installed on the image forming apparatuses 2 and 3 (referred to as “feature information”) in the memory 14, and in response to a request from the image forming apparatus 2 or 3, my-panel information or feature information is returned thereto.

The ROM 12 is a recording medium that stores a program executed by the CPU 11 and other information.

The ROM 13 is a recording medium that provide a working area for the CPU 11 to execute an operation program.

The memory 14, a hard disk drive for example, stores various kinds of information such as my-panel information and feature information, application software, and the like.

The display 15, a CRT or a liquid crystal display for example, displays various messages, various screens such as an entry reception screen, documents created by users, and the like.

The entry portion 16, used by users for entry operations, includes a keyboard, a mouse, and the like.

The network interface 17 functions as a communicator that exchanges information with the image forming apparatuses 2 and 3, and other external machines via the network 4.

In this mode for carrying out the present invention, a MFP that is a multifunctional digital image forming apparatus collectively having a plurality of functions; the copy function, the print function, and other functions, is employed both as the image forming apparatus 2 and 3.

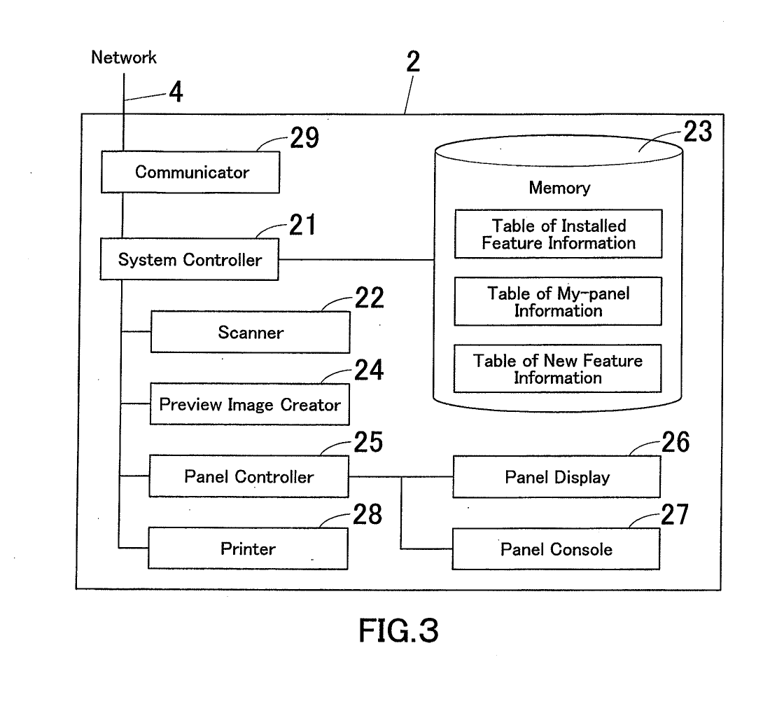

FIG. 3 is a block diagram illustrating a functional configuration of the image forming apparatuses 2 and 3. Since the image forming apparatuses 2 and 3 share a common configuration with each other, a configuration of the image forming apparatus 2 will hereinafter be described while omitting to describe that of the image forming apparatus 3.

The image forming apparatus 2 includes a system controller 21, a scanner 22, a memory 23, a preview image creator 24, a panel controller 25, a panel display 26, a panel console 27, a printer 28, a communicator 29, and the like.

The system controller 21, including a CPU, a RAM, a ROM, and the like not illustrated in this Figure, integrally controls all portions of the image forming apparatus 2. More specifically, in this mode of embodied implementation, the system controller 21 allows users to customize a key selection screen on the panel display 26, with more than one operation mode key to enable a feature of the image forming apparatus 2, being thereon, to make a my-panel without their unnecessary key being thereon, and the system controller 21 also obtains my-panel information originated from a different image forming apparatus via the server 1 and displays a key selection screen that is customized based on the my-panel information. Furthermore, the system controller 21 compares features installed on the image forming apparatus 3 that is the originator machine of the my-panel information (first features) to those installed on the image forming apparatus 2 (second features) and examines if there is a new feature, i.e. there is a second feature that doesn't match any first feature. And if there is a new feature, the system controller 21 creates information of the new feature and displays an operation key to enable this new feature on the panel display 26. Its operations will hereinafter be described in detail.

The scanner 22 reads an image on a document and converts it into image information that is electronic information.

The memory 23, a hard disk drive (HDD) for example, stores various types of application software, data, and the like, and more specifically, in this mode of embodied implementation, stores a table holding feature information of the image forming apparatus 2, a table holding my-panel information including whether or not to display operation keys, and new feature information. New feature information indicates a new feature, i.e. a second feature that does not match any first feature.

The preview image creator 24 creates a preview image of print data to be outputted on the panel display 26, when a user hopes to check it out.

The panel controller 25 delivers what is entered by users via the panel console 27 to the system controller 21, and controls what is displayed on the panel display 26 and how, and the like according to the system controller 21.

The panel display 26 displays various setting screens, such as key selection screens to be described later herein, the state of the image forming apparatus, and a message. It is a liquid crystal display with touch panel functionality, for example.

The panel console 27, used by users for entry operations, includes hardware keys such as numeric keys, a Start key, a Stop key, and the like.

The printer 28 prints out image information read out from a document by the scanner 22, image information received from an external machine such as a user terminal (not illustrated in this Figure), and the like.

The communicator 29 controls communications with the server 1 and external machines such as user terminals, which are connected to the communicator 29 via the network 4.

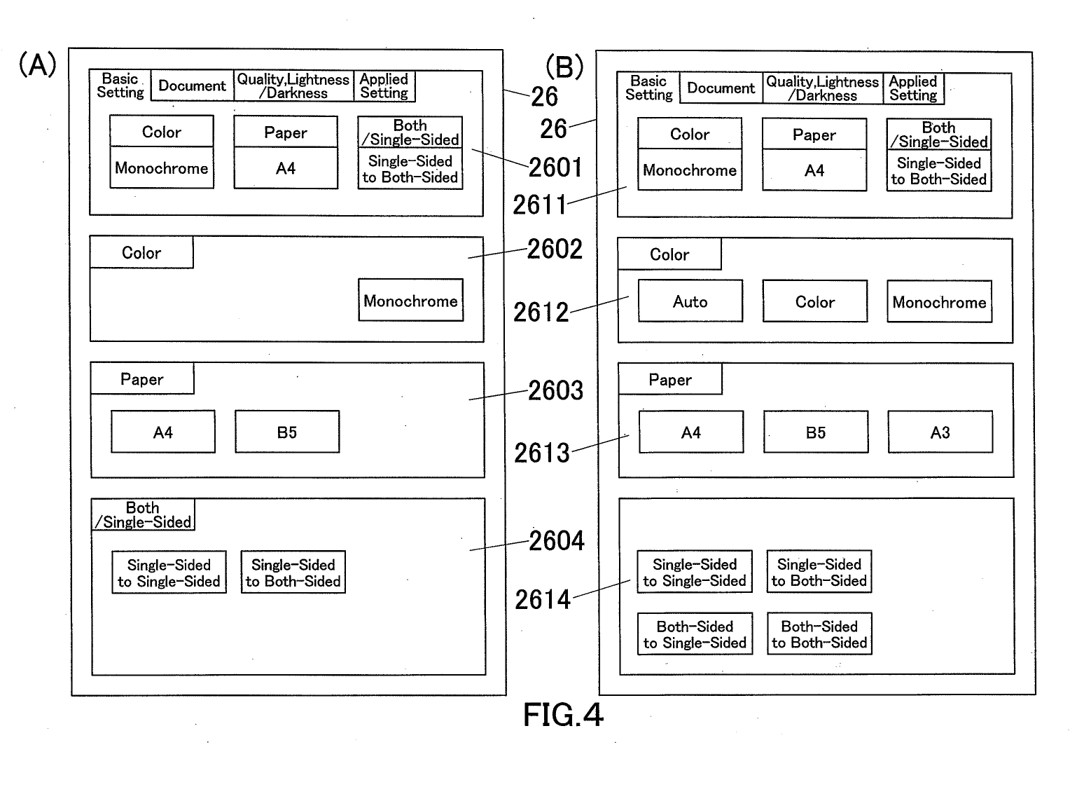

FIG. 4A is a view illustrating a basic setting screen for setting the print function and its lower-class key selection screen displayed on the panel display 26 of the image forming apparatus 2. FIG. 4B is a view illustrating a basic setting screen for setting the print function and its lower-class key selection screen displayed on the panel display 26 of the image forming apparatus 3. As illustrated in FIG. 4A, a basic setting screen 2601 for setting the print function is displayed in the upper region on the panel display 26 of the image forming apparatus 2. This basic setting screen 2601 is a key selection screen with the operation keys: a “Color” key for setting whether color printing mode or monochrome printing mode; a “Paper” key for setting paper size; and a “Both/Single-sided” key for setting whether single-sided printing or both-sided printing, being thereon.

Also, there is a screen 2602; this is a key selection screen connected to the “Color” key, i.e. a lower-class screen under the “Color” key, displayed next when pressing the “Color” key. It should be understood that, practically, a basic setting screen and its lower-class screens would not appear on the panel display 26 all together at the same time, unlike those illustrated in FIG. 4 and its following Figures just for convenience of describing a mode of embodied implementation.

On the key selection screen 2602 that is a lower-class screen under the “Color” key, an operation key with the string “Monochrome” being therein is displayed. With pressing this operation key, the color mode is set to monochrome printing mode.

Also, there is a screen 2603; this is a key selection screen connected to the “Paper” key on the basic setting screen 2601, i.e. a lower-class screen under the “Paper” key, displayed next when pressing the “Paper” key. On the key selection screen 2603, an “A4” key for setting A4-size Paper, and a “B5” key for setting B5-size Paper are displayed.

Also, there is a screen 2604; this is a key selection screen connected to the “Both/Single-sided” key on the basic setting screen 2601, i.e. a lower-class screen under the “Both/Single-sided” key, displayed next when pressing the “Both/Single-sided” key. On the key selection screen 2604, a “Single-sided to Single-sided” key for printing a single-sided document to single-sided paper, and a “Single-sided to Both-sided” key for printing a single-sided document to both-sided paper are displayed.

There are sections with the strings: “Monochrome”, “A4”, and “Single-sided to Both-sided” being therein, under the “Color” key, the “Paper” key, and the “Both/Single-sided” key on the basic setting screen 2601; the strings are the values set via the lower-class screens of the “Color” key, the “Paper” key, and the “Both/Single-sided” key, respectively.

On the other hand, as illustrated in FIG. 4B, a basic setting screen 2611 for setting the print function is displayed in the upper region on the panel display 26 of the image forming apparatus 3. This basic setting screen 2611 is a key selection screen with the operation keys: a “Color” key, a “Paper” key, and a “Both/Single-sided” key, being thereon, which is illustrated in FIG. 4A, just like the basic setting screen 2601 of the image forming apparatus 2.

Also, there is a screen 2612; this is a key selection screen, a lower-class screen under the “Color” key. On the key selection screen 2612, as well as the “Monochrome” key, an “Auto” key for automatically setting whether Color Printing or Monochrome Printing to reproduce original color of a document, and a “Color” key for setting Color Printing are displayed.

Also, there is a screen 2613; this is a key selection screen, a lower-class screen under the “Paper” key on the basic setting screen 2611. On the key selection screen 2613, as well as the “A4” key and the “B5” key, an “A3” key for setting the A3-size paper is displayed.

Also, there is a screen 2614; this is a key selection screen, a lower-class screen under the “Both/Single-sided” key on the basic setting screen 2611. On the key selection screen 2614, as well as the “Single-sided to Single-sided” key and the “Single-sided to Both-sided” key, a “Both-sided to Both-sided” key for copying a both-sided document to both-sided paper is displayed.

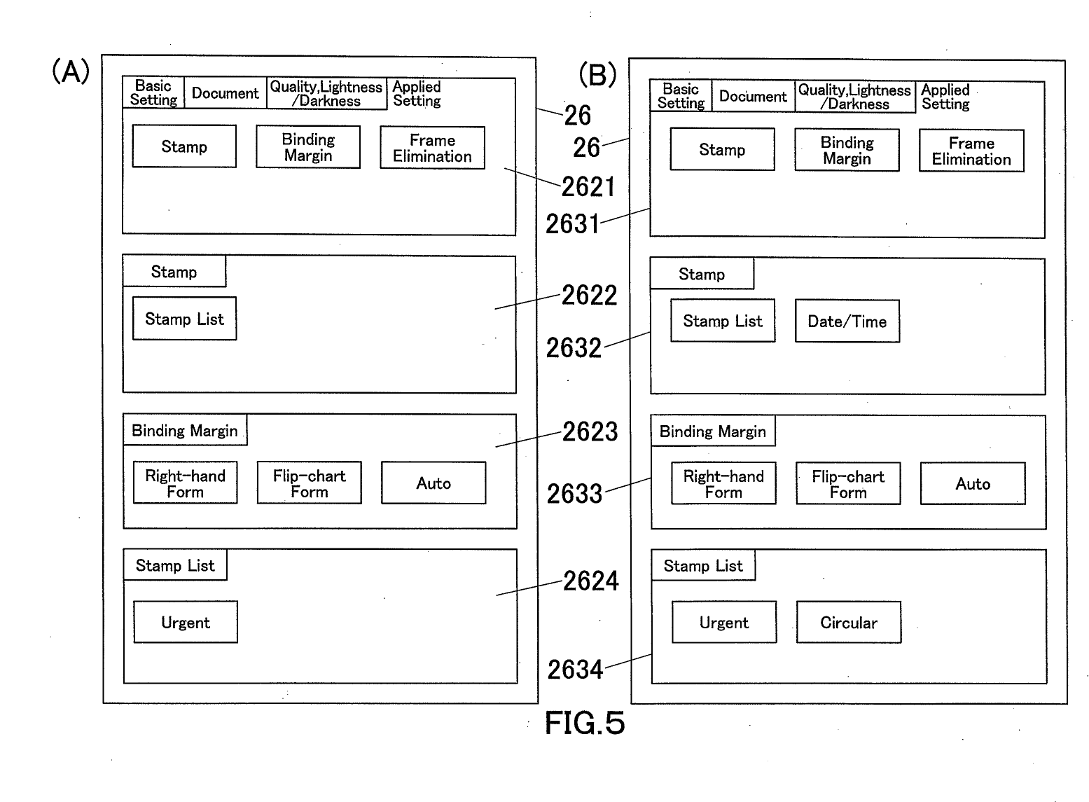

FIG. 5A is a view illustrating an applied setting screen 2621 for setting the print function and its lower-class key selection screen, displayed on the panel display 26 of the image forming apparatus 2. This applied setting screen 2621 is a key selection screen with the operation keys: a “Stamp” key for giving a stamp on paper, a “Binding Margin” key for keeping space for binding, and an “Unframed” key for eliminating a frame, being thereon.

Also, there is a screen 2622; this is a key selection screen connected to the “Stamp” key, i.e. a lower-class screen under the “Stamp” key, displayed next when pressing the “Stamp” key. On the key selection screen 2622, a “Stamp List” key for setting a stamp is displayed. With pressing the “Stamp List” key on the key selection screen 2622, the screen is switched to a key selection screen 2624 that is a lower-class screen under the key. There is an “Urgent” key on the key selection screen 2624; and with pressing the “Urgent” key, a stamp of the string “Urgent” can be printed on paper.

Also, there is a screen 2623; this is a key selection screen connected to the “Binding Margin” key on the applied setting screen 2621, i.e. a lower-class screen under the “Binding Margin” key, displayed next when pressing the “Binding Margin” key. On the key selection screen 2623, a “Right-hand Form” key for keeping space for binding in the right area of paper so that pages can be turned from left to right; a “Flip-chart Form” key for keeping space for binding in the top area of paper so that pages can be turned from bottom up; and an “Auto” key for automatically setting whether Right-hand Form or Flip-chart Form are displayed.

FIG. 5B is a view illustrating an applied setting screen 2631 for setting the print function and its lower-class key selection screen, displayed on the panel display 26 of the image forming apparatus 3. This applied setting screen 2631 is a key selection screen with the operation keys: a “Stamp” key, a “Binding Margin” key, and a “Unframed” key, being thereon, which is illustrated in FIG. 5A, just like in the case of the image forming apparatus 2.

Also, there is a screen 2632; this is a key selection screen, a lower-class screen under the “Stamp” key on the applied setting screen 2631. On the key selection screen 2632, as well as the “Stamp List” key, a “Date/Time” key for printing a stamp of a date and time of occurrence of the printing event on paper is displayed. With pressing the “Stamp List” key on the key selection screen 2632, the screen is switched to a key selection screen 2634 that is a lower-class screen under the key. As well as the “Urgent” key, a “Circular” key is displayed on the key selection screen 2634; and with pressing the “Circular” key, a stamp of the string “Circular” can be printed on paper.

Also, there is a screen 2633; this is a key selection screen, a lower-class screen under the “Binding Margin” key on the applied setting screen 2631. On the key selection screen 2633, a “Right-hand Form” key, a “Flip-chart Form” key, and an “Auto” key are displayed.

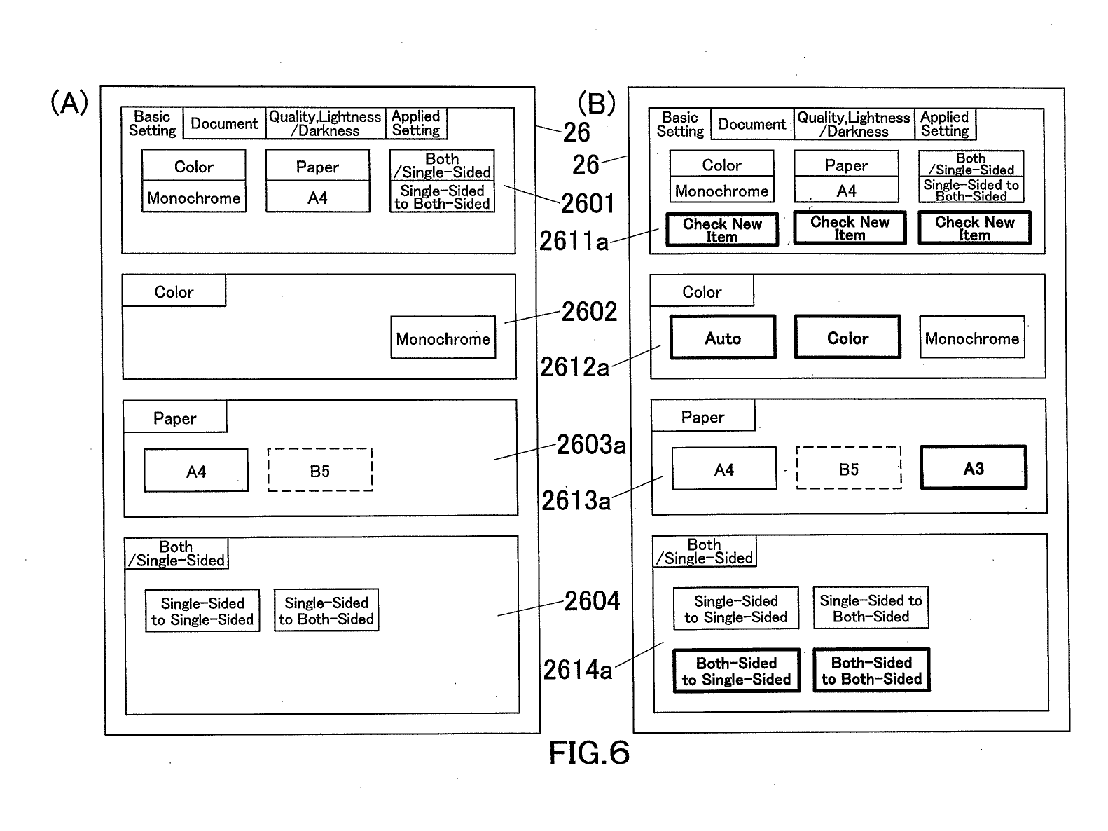

FIG. 6A is a view illustrating an example of a my-panel that is a customized screen without a predetermined operation key being thereon, displayed on the panel display of the image forming apparatus 2. Different my-panels may be created for every user, or one my-panel may be commonly created for all users.

On this my-panel, the “B5” key does not appear on the key selection screen 2603a that is a lower-class screen under the “Paper” key on the basic setting screen 2601, according to the setting for the “B5” key. In the FIG. 6 and its following Figures, operation keys to be hidden according to the setting are outlined with a dashed line. With pressing the “Paper” key via the basic setting screen 2601, the screen is switched to a key selection screen 2603a; however, the “B5” key will not appear thereon.

FIG. 6B is a view illustrating a basic setting screen that is displayed on the panel display 26 of the image forming apparatus 3 after obtaining my-panel information to reproduce the my-panel illustrated as FIG. 6A, which is a screen customized on the image forming apparatus 2. The my-panel information is obtained via the server 1.

In other words, the image forming apparatus 2 creates the my-panel and transmits the my-panel information to the server 1, and then the server 1 stores the my-panel information on the memory 14. And a user, for example, an administration-level user accesses the server 1 from the image forming apparatus 3 and requests for his/her own my-panel information; in response to the request, the server 1 transmits the my-panel information to the image forming apparatus 3. The my-panel information received in that way is recorded in the table of my-panel information on the memory 23 of the image forming apparatus 3.

Since the my-panel information received by the image forming apparatus 3 includes model information of the image forming apparatus 2 that is the originator of the my-panel information, the image forming apparatus 3 requests the server 1 for feature information of the image forming apparatus 2 according to the model information. Receiving the feature information from the server 1, the image forming apparatus 3 records it in the table of feature information on the memory 23.

Subsequently, the image forming apparatus 3 compares the installed feature information of the image forming apparatus 2, obtained via the server 1, to features installed on the image forming apparatus 3 itself; detects new feature items existing in the image forming apparatus 3 but not in the image forming apparatus 2, at least those of the print function; the table of new feature information stored on the memory 23 is updated with the detected items; and displays a key selection screen with the new feature items being thereon, on the panel display 26, as illustrated in FIG. 6B.

In this mode of embodied implementation, as it would be understood with reference to FIG. 4A and 4B, the new features in the basic setting category, installed on the image forming apparatus 3 but not on the image forming apparatus 2 are, for example: Color Printing enabled by a “Color” key for setting Color Printing, Auto Printing enabled by an “Auto” key for automatically setting whether Color Printing or Monochrome Printing, A3-size paper enabled by an “A3” key for setting A3-size paper, Both-sided-to-single-sided Printing enabled by a “Both-sided to Single-sided” key for copying a both-sided document to single-sided paper, and Both-sided-to-both-sided printing enabled by a “Both-sided to Both-sided” key for copying a both-sided document to both-sided paper.

Thus, on a basic setting screen 2611a illustrated in FIG. 6B, “Check New Item” icons are displayed below the operation keys: the “Color” key, the “Paper” key, and the “Both/Single-sided” key, under which operation keys corresponding to the new feature items will appear on a lower-class screen, so that users can know new features of Color Printing, Paper Type, and Both/Single-sided have been installed.

On a key selection screen 2612a that is a lower-class screen displayed next when pressing the “Color” key via the basic setting screen 2611a, now the new feature items, the “Auto” key and the “Color” key are displayed with a distinct looking, for example, in a different color and line weight than the other operation keys originated from the image forming apparatus 2. In FIG. 6, these operation keys look distinct with its key frames and the strings therein both being displayed in bold.

On a key selection screen 2613a that is a lower-class screen displayed next when pressing the “Paper” key via the basic setting screen 2611a, now the new feature items, the “A3” key is displayed with a distinct looking than the other operation keys originated from the image forming apparatus 2. However, the “B5” key does not appear on the image forming apparatus 3, since the setting for the key has been changed from display to non-display when the my-panel was customized on the image forming apparatus 2.

On a key selection screen 2614a that is a lower-class screen displayed next when pressing the “Both/Single-sided” key via the basic setting screen 2611a, now the new feature items, the “Both-sided to Single-sided” key and the “Both-sided to Both-sided” key are displayed with a distinct looking than the other operation keys originated from the image forming apparatus 2.

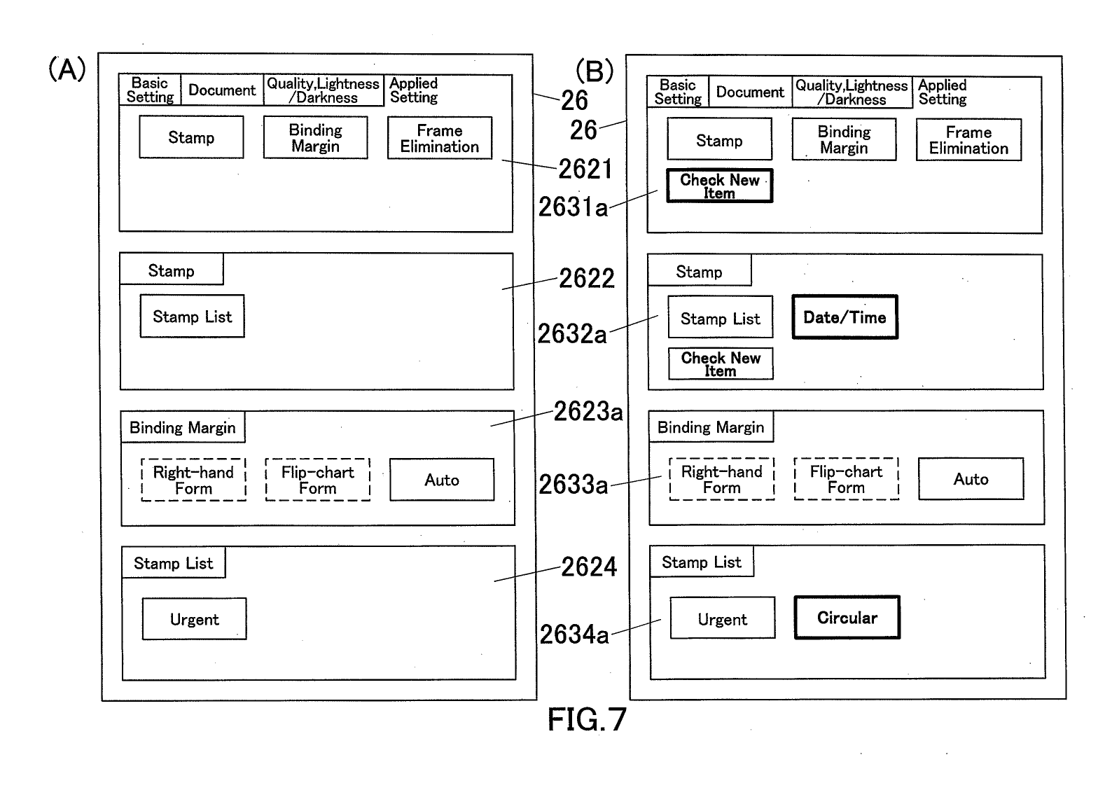

FIG. 7A is a view illustrating an example of a my-panel that is a customized applied setting screen without a predetermined operation key being thereon, displayed on the image forming apparatus 2. In connection with the my-panel, the settings of the “Right-hand Form” key and the “Flip-chart Form” on a key selection screen 2623a, i.e. a lower-class screen under the “Binding Margin” key on the applied setting screen 2621 have been changed from display to non-display.

Accordingly, when pressing the “Binding Margin” key via the applied setting screen 2621, the screen will be switched to the key selection screen 2623a without the “Right-hand Form” key and the “Flip-chart Form” being thereon.

FIG. 7B is a view illustrating an applied setting screen that is displayed on the panel display 26 of the image forming apparatus 3 after obtaining my-panel information to reproduce the my-panel illustrated as FIG. 7A.

In this mode of embodied implementation, as it would be understood with reference to FIG. 5A and 5B, the new features in the applied setting category, installed on the image forming apparatus 3 but not on the image forming apparatus 2 are, for example: Date/Time Stamp enabled by a “Date/Time” key for printing a stamp of a date and time; and Circular Stamp enabled by a “Circular” key for printing a stamp of the string “Circular”.

Thus, on an applied setting screen 2631a illustrated in FIG. 7B, a “Check New Item” icon is displayed below the “Stamp” key, under which operation keys corresponding to the new feature items will appear on a lower-class screen, so that users can know new features of stamp printing have been installed.

On a key selection screen 2632a that is a lower-class screen displayed next when pressing the “Stamp” key via the applied setting screen 2631a, now the new feature item, the “Date/Time” key is displayed with a distinct looking than the other operation keys originated from the image forming apparatus 2.

On a key selection screen 2634a that is a lower-class screen displayed next when pressing the “Stamp List” key via the screen 2632a, now the new feature items, the “Circular” key is displayed with a distinct looking than the other operation keys originated from the image forming apparatus 2.

As described above, when the image forming apparatus 3 displays a my-panel on the panel display 26 based on my-panel information originated from the image forming apparatus 2, users can know via the panel display 26 quite easily if a new feature not installed on the image forming apparatus 2 has been installed on the image forming apparatus 3. If a new feature has been installed, operation keys corresponding to new feature items will appear on the panel display 26, so users can use the new features by pressing those operation keys.

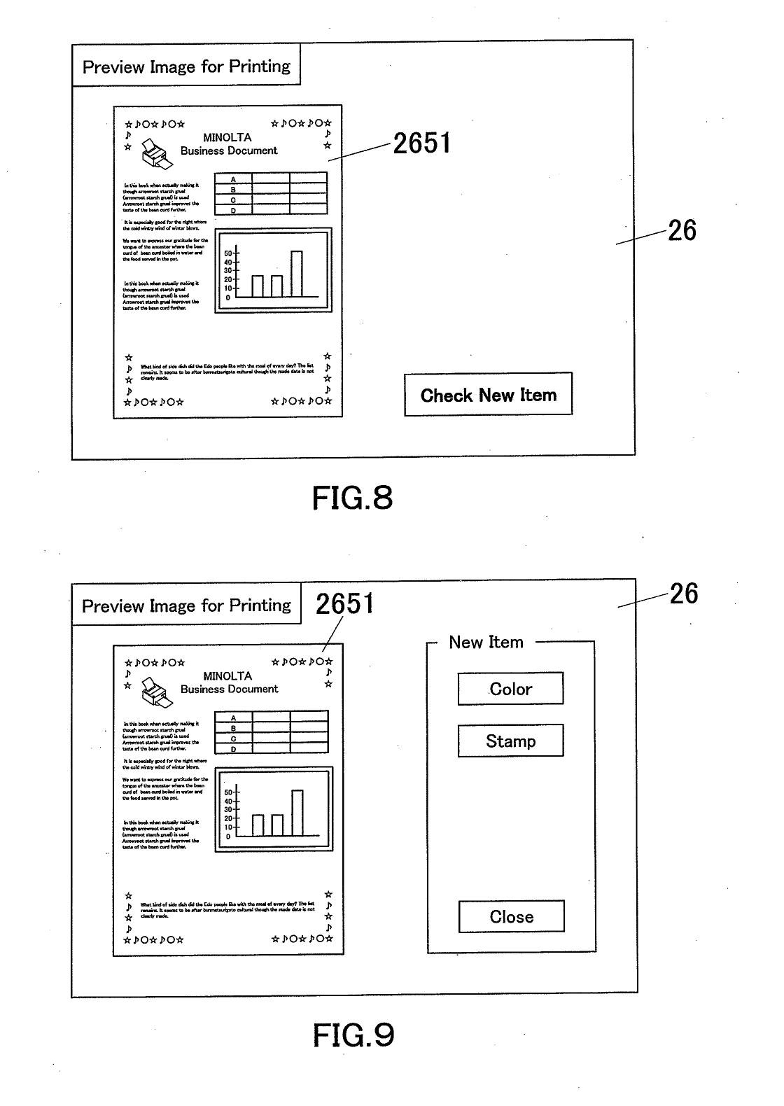

FIGS. 8 to 11 relate to another mode of embodied implementation of the present invention. For example, in this mode of embodied implementation, as soon as a user displays a preview image 2651 of image data read out by the scanner 22 or of print data such as data stored on the memory 23, on the panel display 26 before printing, he/she can know via the panel display 26 if a new feature not installed on the image forming apparatus 2 has been installed on the image forming apparatus 3. The preview image 2651 is monochrome, and it was created by the image forming apparatus 2 with use of its own feature, monochrome printing.

In other words, the image forming apparatus 3 obtains my-panel information originated from the image forming apparatus 2 via the server 1 and uses it. When the user specifies a print data object and presses a “Preview” key not illustrated in the Figures, using the image forming apparatus 3, a preview image to be outputted by the printer 28 will be displayed on the panel display 26 as illustrated in FIG. 8.

At the same time, a “Check New Item” icon will appear thereon; and finding this icon, the user can know quite easily that a new feature not installed on the image forming apparatus 2 has been installed on the image forming apparatus 3.

Subsequently, when the user presses the “Check New Item” key, the screen will be switched to another screen illustrated in FIG. 9. On this screen, operation keys corresponding to new feature items are displayed with the preview image of the print data object.

For example, in FIG. 9, a “Color” key and a “Stamp” key are displayed thereon as the operation keys corresponding to the new feature items.

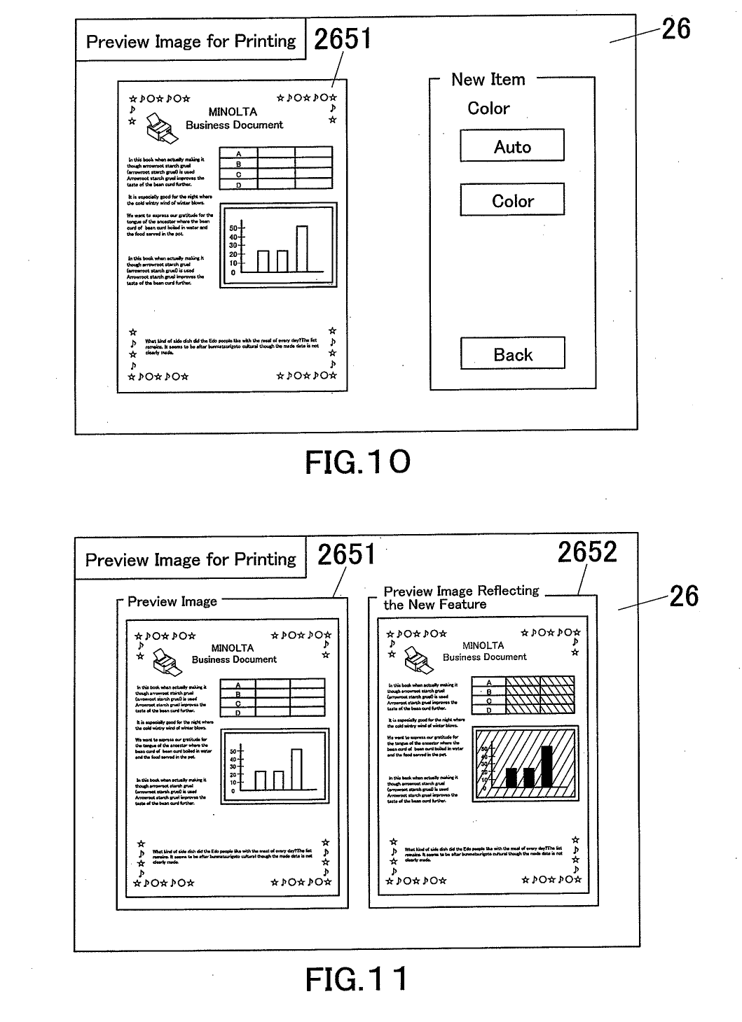

When the user presses the “Color” key, a lower-class screen under the “Color” key, with two operation keys: an “Auto” key and a “Color” key being thereon, will be displayed as illustrated in FIG. 10. These operation keys are for setting new features not installed on the image forming apparatus 2; the “Auto” key is for automatically setting whether Color Printing or Monochrome Printing to reproduce original color of a document, and the “Color” key is for setting Color Printing.

With pressing the “Stamp” key via the screen of FIG. 9, a “Stamp List” key not illustrated in this Figure, is displayed. Subsequently, with pressing the “Stamp List” key, a “Circular” key for printing a stamp of the string “Circular”, which is a new feature not installed on the image forming apparatus 2, is displayed.

With pressing the “Color” key, for example, via the screen of FIG. 10, the screen is switched to another screen as illustrated in FIG. 11. On this screen, a monochrome preview image 2651 created with use of Monochrome Printing and a color preview image 2652 created with use of Color Printing are displayed side by side with each other. Checking out the screen, users can answer quite easily whether or not to print it out using the new feature.

In the modes of embodied implementation illustrated in FIGS. 8, 9, and 10, the new feature items related to quality of an image to be outputted, which are the “Color” key and the “Stamp” key are displayed, while a new feature item not related to image quality, for example, an operation key for setting paper size is not displayed. However, the operation keys for setting paper size may be displayed.

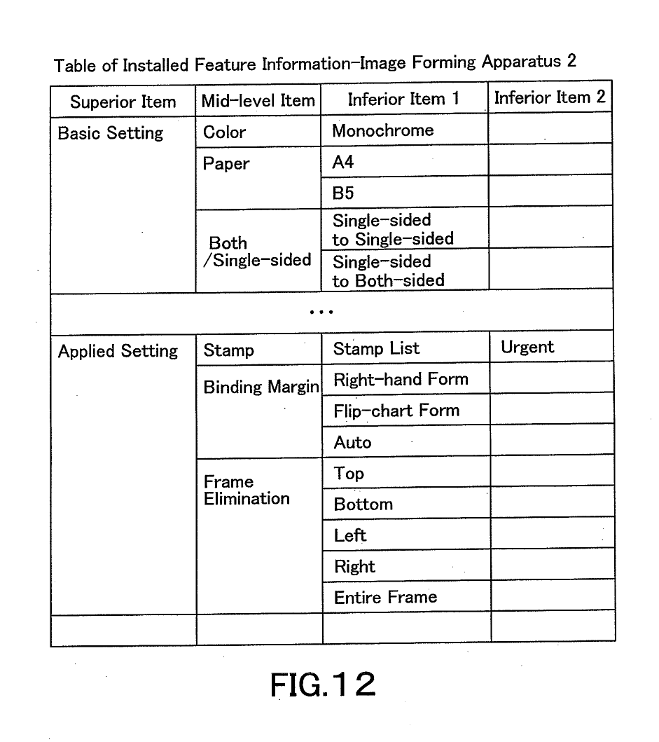

FIG. 12 is a view illustrating a table of installed feature information stored on the memory 23 of the image forming apparatus 2. Also, the table of installed feature information is stored on the memory 23 of the server 1.

The image forming apparatus 2 has a basic setting category and an applied setting category as superior feature items. There are Color Setting, Paper Size Setting, and Both/Single-sided Print Setting (mid-level items) in a lower class than the basic setting category, and there is Monochrome (Black) Printing (inferior item 1) in a lower class than Color Setting. And there are A4-size Paper and B5-size Paper (inferior item 1) in a lower class than Paper Size. Furthermore, there are the feature of printing a single-sided document to single-sided paper and the feature of printing a single-sided document to both-sided paper (inferior items 1) in a lower class than Both/Single-sided Print Setting. Operation keys to enable these features are displayed as illustrated in FIG. 4A.

Meanwhile, there are Print Stamp, Binding Margin, and Frame Elimination (mid-level item) in a lower class than the applied setting category. There is Stamp List (inferior item 1) in a lower class than Print Stamp, and there is the feature of printing a stamp of the string “Urgent” (inferior item 2) in a lower class than Stamp List.

And there are Right-hand Form, Flip-chart Form, and Auto (inferior item 1) in a lower class than Biding Margin. Furthermore, there are Top, Bottom, Left, Right, and Entire Frame (inferior items 1) in a lower class than Frame Elimination. Operation keys to enable these features are displayed as illustrated in FIG. 5A. In FIG. 5A, display of operation keys to enable the features in a class lower than Frame Elimination is omitted.

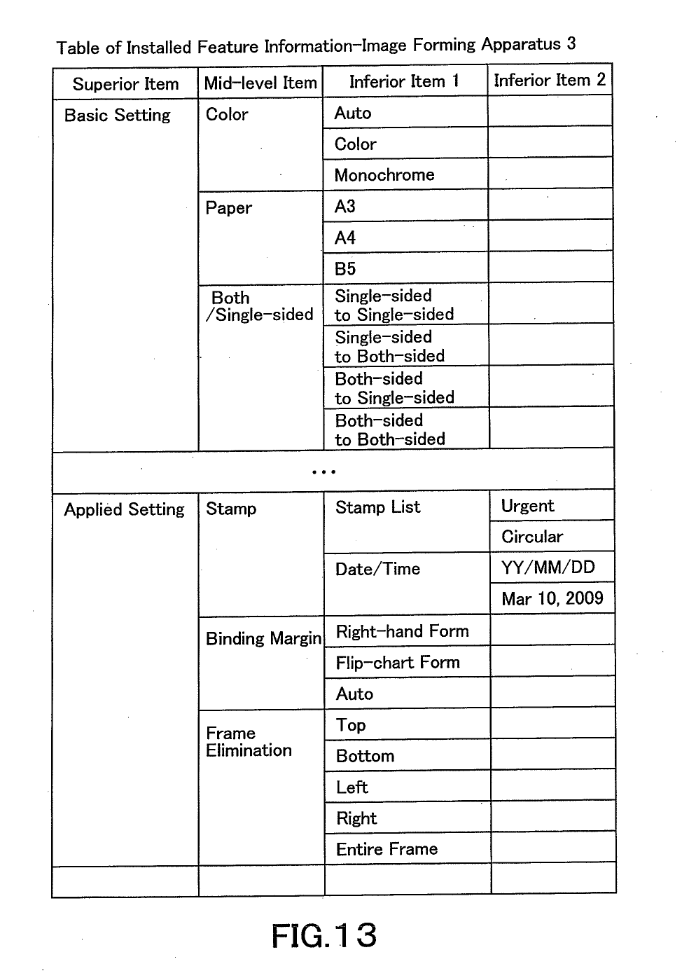

FIG. 13 is a view illustrating a table of installed feature information stored on the memory 23 of the image forming apparatus 3.

In connection with the basic setting category, Auto Color Printing and Color Printing (inferior items 1) in a lower class than Color Setting have newly been installed on the image forming apparatus 3, in addition to the features installed on the image forming apparatus 2 listed in FIG. 12. Also, A3-size Paper (inferior item 1) in a lower class than Paper Size has newly been installed thereon. Furthermore, the feature of printing a both-sided document to single-sided paper and the feature of printing a both-sided document to both-sided paper (inferior items 1) in a lower class than Both/Single-sided Print Setting have newly been installed thereon. Operation keys to enable these features are displayed as illustrated in FIG. 4B.

Similarly, in connection with the applied setting category, the feature of printing a stamp of the string “Circular” (inferior item 2) in a lower class than Stamp List (inferior item 1) in a further lower class than Print Stamp; Date/Time Stamp (inferior item 1) in a lower class than Print Stamp; and two styles of a stamp of a date and time (inferior items 2) in a lower class than Date/Time Stamp have newly been installed thereon. Operation keys to enable these features are displayed as illustrated in FIG. 5B. In FIG. 5B, display of operation keys to enable these features in a class lower than Date/Time Stamp is omitted.

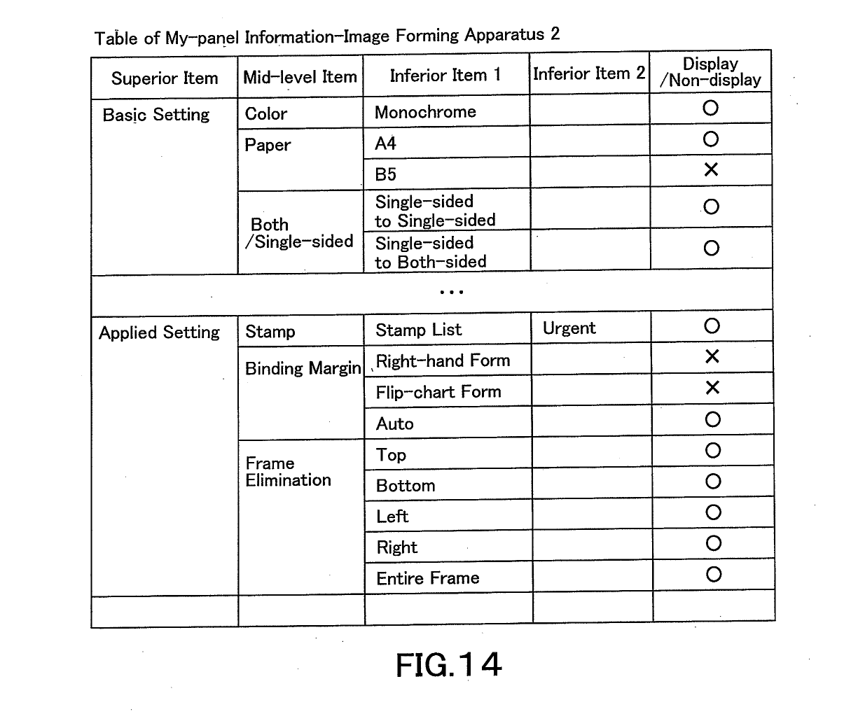

FIG. 14 is a view illustrating a table of my-panel information stored on the memory 23 of the image forming apparatus 2. Also, this table of my-panel information is stored on the memory 14 of the server 1.

According to the table of my-panel information in FIG. 14, each of the operation keys for setting the installed features listed in FIG. 12 is set to “Display” (marked with a circle) or “Non-display” (marked with an X). More specifically, in this example, as previously described, the “B5” key supposed to appear when pressing the “Paper” key via the basic setting screen; and the “Right-hand Form” key and the “Flip-chart Form” key supposed to appear when pressing the “Binding Margin” key via the applied setting screen, will not be displayed.

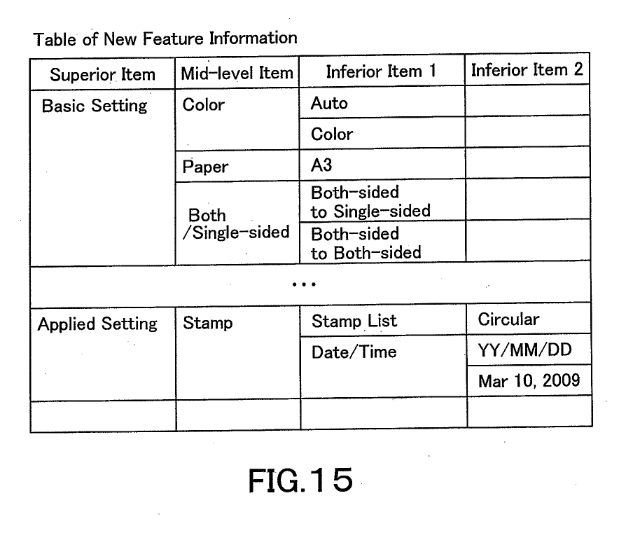

FIG. 15 is a view illustrating a table of new feature information stored on the memory 23 of the image forming apparatus 3. This new feature information is created by comparing the table of installed feature information (FIG. 12) of the image forming apparatus 2, obtained via the server 1, to the table of installed feature information (FIG. 13) of the image forming apparatus 2.

More specifically, in connection with the basic setting category, Auto Color Printing and Color Printing (inferior items 1) in a lower class than Color Setting; A3-size Paper (inferior item 1) in a lower class than Paper Size; and Both-sided-to-single-sided Printing and Both-sided-to-both-sided Printing (inferior items 1) in a lower class than Both/Single-sided Print Setting are detected and recorded in the table of new feature information, as new features, i.e. those installed on the image forming apparatus 3 but not on the image forming apparatus 2.

Similarly, in connection with the applied setting category, Circular Stamp (inferior item 2) in a lower class than Stamp List (inferior item 1) in a further lower class than Print Stamp; Date/Time Stamp (inferior item 1) in a lower class than Print Stamp; and two styles of a stamp of a date and time (inferior item 2) in a lower class than Date/Time Stamp are detected and recorded in the table of new feature information, as the new features.

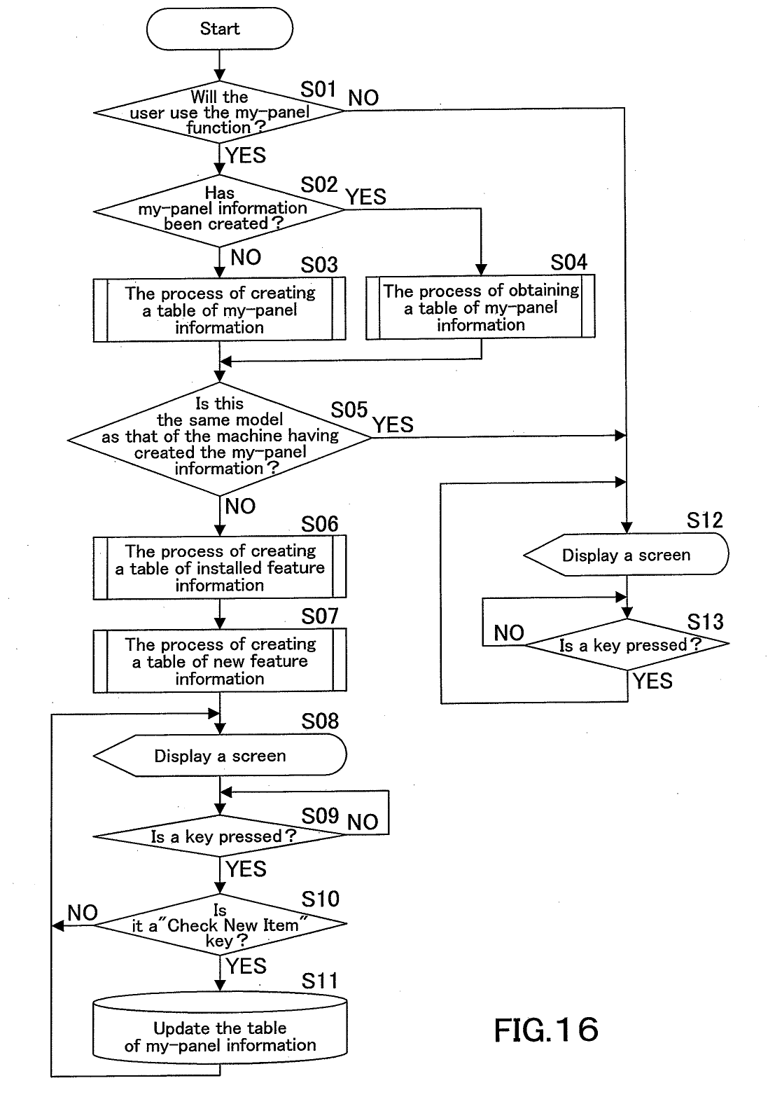

FIG. 16 is a flowchart to describe a processing routine to display a key selection screen on the panel display 26 of the image forming apparatus 3. This processing routine is executed by a CPU of the system controller 21 of the image forming apparatus 3, not illustrated in this Figure, according to an operation program stored on a recording medium such as a ROM not illustrated in this Figure, or the memory 23.

In Step S01, it is judged whether or not to use the my-panel function according to a user operation. If the user will not use it (NO in Step S01), the routine goes to Step S12 to display an ordinary (default) key selection screen on the panel display 26. In Step S13, it is judged whether or not an operation key is pressed. If no operation key is pressed (NO in Step S13), the routine waits until an operation key is pressed. If an operation key is pressed (YES in Step S13), the routine goes back to Step S12 to display a key selection screen or the like, a lower-class screen under the pressed key.

In Step S01, if the user will use the my-panel function (YES in Step S01), then it is judged in Step S02, whether or not my-panel information has been created for the user. If it has not been created before (NO in Step S02), the process of creating a table of my-panel information is executed in Step S03, and then the routine goes to Step S05. The My-panel information created by the process is transmitted to the server 1 together with model information of the image forming apparatus 3, then stored on the memory 14 of the server 1.

In Step S02, if my-panel information has been created for the user (YES in Step S02), the process of obtaining a table of my-panel information is executed in Step S04, and then the routine goes to Step S05. The process of creating a table of my-panel information and the process of obtaining a table of my-panel information will be described later herein.

In Step S05, it is judged whether or not the model of the image forming apparatus 3 is the same as that of the machine having created the my-panel information obtained in Step S04. More specifically, model information is attached to the obtained my-panel information, and the judgment is done by comparing this model information to the model of the image forming apparatus 3.

If the models of these two image forming apparatuses are the same (YES in Step S05), this means that features installed thereon also are the same, and the routine goes to Step S12. If the my-panel information is not obtained from the server 1, the judgment result drawn in Step S05 will be YES.

If the models are not the same (NO in Step S05), the process of creating a table of installed feature information is executed in Step S06, and then the process of creating a table of new feature information is executed in Step S07. These processes will be described later herein.

Subsequently, in Step S08, a key selection screen is displayed on the panel display 26, with use of the obtained my-panel information. On this key selection screen, “Check New Item” icons and/or operation keys corresponding to new feature items are displayed as illustrated in FIGS. 6B and 7B. Similarly, when the user calls out a preview image of print data, “Check New Item” icons and/or operation keys corresponding to new feature items are displayed thereon, as illustrated in FIGS. 8 through 11.

And in Step S09, the routine waits until an operation key is pressed. If an operation key is pressed (YES in Step S09), then it is judged in Step S10, whether or not it is a “Check New Item” key.

If it is not a “Check New Item” key, (NO in Step S10), the routine goes back to Step S08 to display a key selection screen or the like, a lower-class screen under the key. If it is a “Check New Item ” key (YES in Step S10), the table of my-panel information is changed so that the key will be displayed on the my-panel, and then the routine goes back to Step S08. According to the change in the table of my-panel information, the table of my-panel information stored on the server 1 will also be updated.

As described above, with pressing of a “Check New Item” key, a table of my-panel information is automatically changed so that an operation key to enable a new feature will be displayed on a my-panel. Therefore, users and the like do not have to bother manually adding an operation key to enable a new feature onto their my-panels.

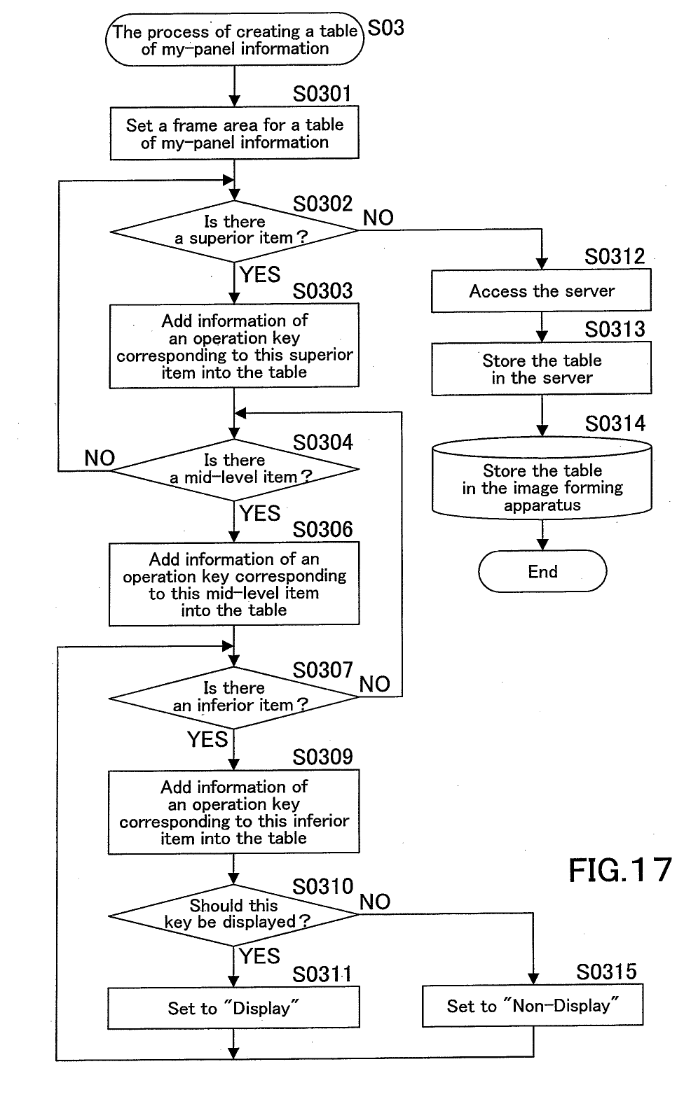

FIG. 17 is a flowchart representing a sub routine to make a table of my-panel information, which corresponds to Step S03 of FIG. 16.

A frame area is set for a table of my-panel information in Step S0301, and it is judged in Step S0302, whether or not there is a superior feature item. If there is a superior item (YES in Step S0302), information of an operation key corresponding to the superior item is added into the table in Step S0303.

And it is judged in Step S0304, whether or not there is a mid-level feature item under the superior item. If there is a mid-level item (YES in Step S0304), information of an operation key corresponding to the mid-level item is added into the table in Step S0306.

And then, it is judged in Step S0307, whether or not there is an inferior feature item under the mid-level item. If there is an inferior item (YES in Step S0307), information of an operation key corresponding to the inferior item is added into the table in Step 50309.

Subsequently, it is judged in Step S0310, whether or not the operation key corresponding to the inferior item should be displayed, according to a user operation. If it should be displayed (YES in Step S0310), the operation key is set to “Display” in Step S0311. If it does not have to be displayed (NO in Step S0310), the operation key is set to “Non-display” in Step S0315. After setting “Display” or “Non-display”, the routine goes back to Step S0307 to judge whether or not there is another inferior item under the mid-level item. And if there is another inferior item, an operation key corresponding to this item is set to “Display” or “Non-display” in the same way as described above.

In Step S0307, if there is no inferior item (NO in Step S0307), the routine goes to Step S0304 to judge whether or not there is another mid-level item. If there is another mid-level item (YES in Step S0304), the routine goes to Step S0306 to repeat Steps S0306 to S0311 and S0315 in the same way as described above.

In Step S0304, if there is no mid-level feature item (NO in Step S0304), then it is judged in Step S0302, whether or not there is another superior item in Step S0302. If there is another superior item (YES in Step S0304), the routine goes to Step S0303 to repeat Steps S0303 to S0311 and S0315 in the same way as described above.

As described above, whether or not there is a mid-level item under each superior feature item and there is an inferior item under each mid-level feature item are judged. And if there is a mid-level item or an inferior item, information of an operation key corresponding to this item is added into the table. Furthermore, an operation key corresponding to the inferior item is set to “Display” or “Non-display”.

Meanwhile, operation keys corresponding to the mid-level item and the superior item may be set to “Non-display”. In this case, lower-class operation keys under the operation keys to be hidden according to the “Non-display” setting will be all gone.

In Step S0302, if there is no superior feature item (NO in Step S0302), this means that all feature items are completely checked out, so the routine goes to Step S0312 to access the server 1, and the table of my-panel information having just been made is stored on the memory 14 of the server 1 in Step 50313. Then in Step S0314, the table of my-panel information is stored on the memory 23 of the image forming apparatus 3.

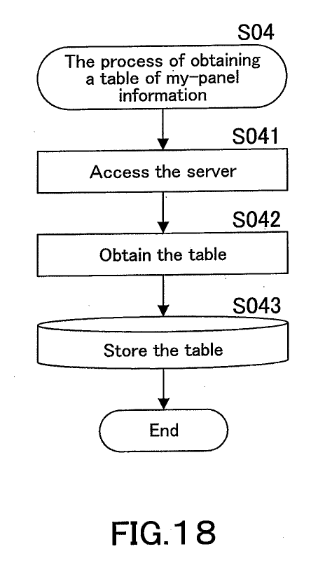

FIG. 18 is a flowchart representing a sub routine to obtain a table of my-panel information, which corresponds to Step S04 of FIG. 16.

The image forming apparatus 3 accesses the server 1 in Step S041, and therefrom obtains the table of my-panel information created by the image forming apparatus 2 in Step S042.

And in Step S043, the obtained table of my-panel information is stored on the memory 23.

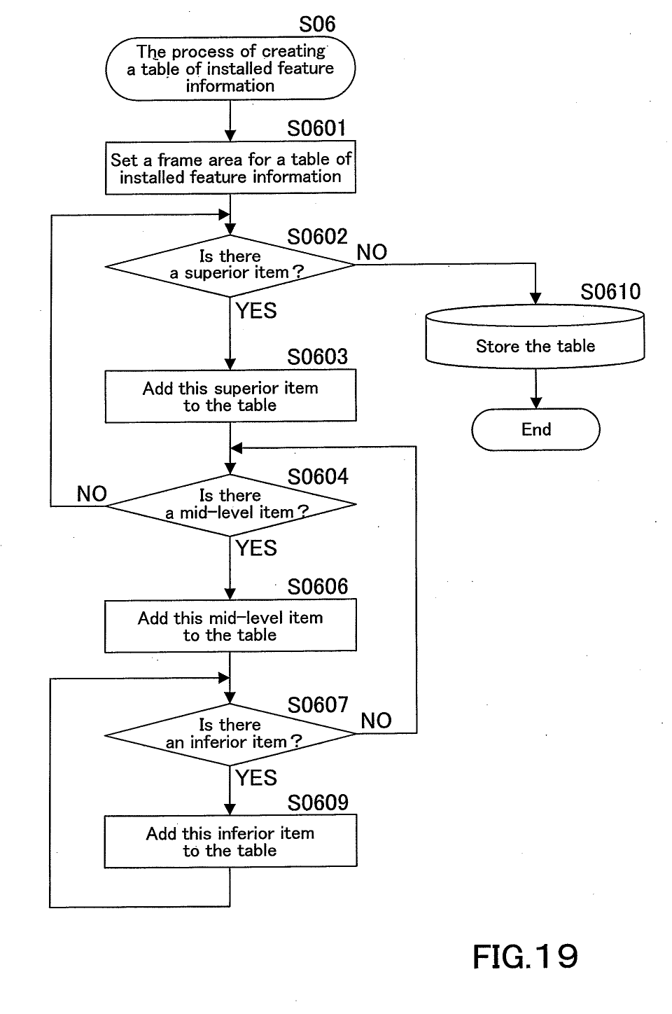

FIG. 19 is a flowchart representing a sub routine to make a table of installed feature information, which corresponds to Step S06 of FIG. 16.

A frame area is set for a table of installed feature information in Step S0601, and it is judged in Step S0602, whether or not there is a superior feature item. If there is a superior item (YES in Step S0602), the superior item is added into the table in Step S0603.

And it is judged in Step S0604, whether or not there is a mid-level feature item under the superior item. If there is a mid-level item (YES in Step S0604), the mid-level item is added into the table in Step S0606.

And then, it is judged in Step S607, whether or not there is an inferior feature item under the mid-level item. If there is an inferior item (YES in Step S0607), the inferior item is added into the table in Step S0609. After that, the routine goes back to Step S0607 to judge whether or not there is another inferior item under the same mid-level item, and if there is, the inferior item is added into the table in the same way as described above.

In Step S0607, if there is no inferior item (NO in Step S0607), the routine goes to Step S0604 to judge whether or not there is another mid-level item. If there is another mid-level item (YES in Step S0604), the routine goes to Step S0606 to repeat Steps S0606 through S0619 in the same way as described above.

In Step S0604, if there is no mid-level feature (NO in Step S0604), then it is judged in Step S0602, whether or not there is another superior item in Step S0602. If there is another superior item (YES in Step S0604), the routine goes to Step S0603 to repeat Steps S0603 through S0319 in the same way described above.

As described above, whether or not there is a mid-level item under each superior feature item is judged and subsequently whether or not there is an inferior item under each mid-level feature item is judged. And if there is a mid-level item or an inferior item, it is added into the table.

In Step S0602, if there is no superior feature item (NO in Step S0602), this means that all feature items are completely checked out, so the table of installed feature information having just been made is stored on the memory 23 in Step S0610.

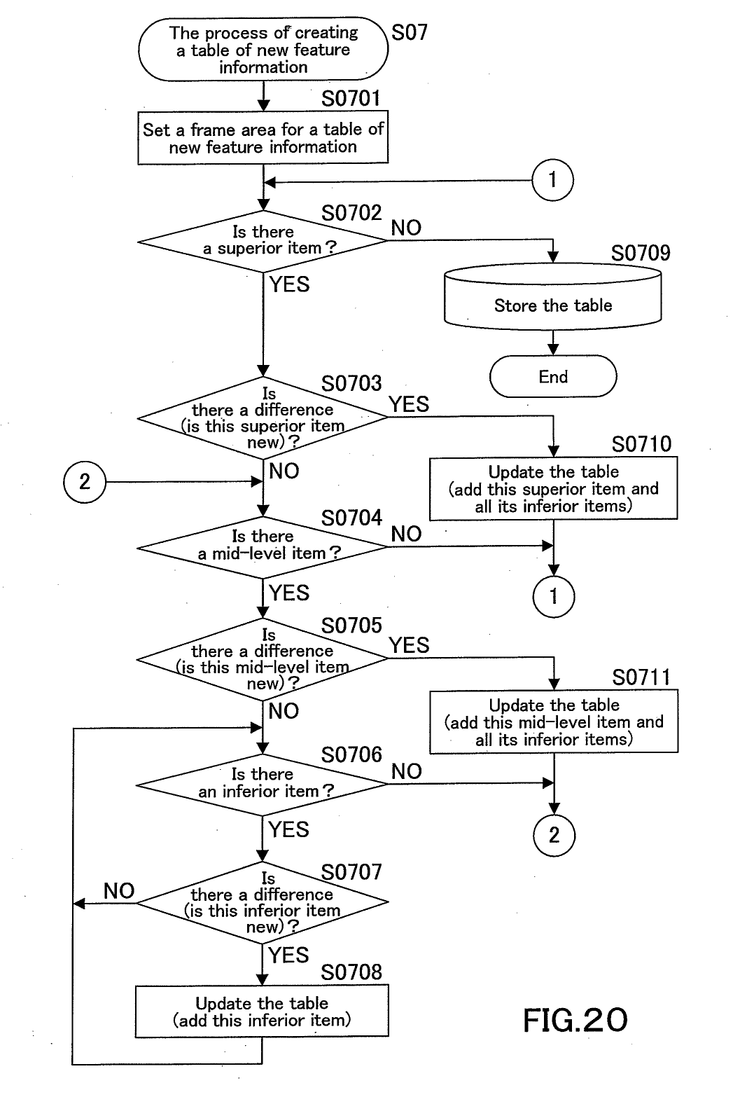

FIG. 20 is a flowchart representing a sub routine to make a table of new feature information, which corresponds to Step S07 of FIG. 16. In this process, the image forming apparatus 3 compares the table of installed feature information of its own, having just been made in Step S06 of FIG. 16, to the table of installed feature information of the image forming apparatus 2.

A frame area is set for a table of new feature information in Step S0701, and it is judged in Step S0702, whether or not there is a first superior feature item in the table of installed feature information of the image forming apparatus 3. If there is a superior item (YES in Step S0702), then it is judged in Step S0703, whether or not there is a difference, i.e. the superior item exists in the table of installed feature information of the image forming apparatus 3 but does not exist in that of the image forming apparatus 2 obtained via the server 1. If the superior item exists only in the table of installed feature information of the image forming apparatus 3 (YES in Step S0703), the table of new feature information is updated with this superior item and all mid-level and inferior items under the superior item in Step S0710, and then the routine goes back to Step S0702 to judge whether or not there is another superior item.

If there is no difference in Step S0703 (NO in Step S0703), then it is judged in Step S0704, whether or not there is a mid-level item under the superior item in the table of installed feature information. If there is no mid-level item (NO in Step S0704), the routine goes back to Step S0702.

If there is a mid-level item (YES in Step S0704), then it is judged in Step S0705, whether or not there is a difference, i.e. the mid-level item exists in the table of installed feature information of the image forming apparatus 3 but does not exist in that of the image forming apparatus 2 obtained via the server 1. If the mid-level item exists only in the table of installed feature information of the image forming apparatus 3 (YES in Step S0705), the table of new feature information is updated with this mid-level item and all inferior items under the mid-level item in Step S0711, and then the routine goes back to Step S0704 to judge whether or not there is another mid-level item.

If there is no difference in Step S0705 (NO in Step S0705), then it is judged in Step S0706, whether or not there is an inferior item under the mid-level item in the table of installed feature information. If there is no inferior item (NO in Step S0706), the routine goes back to Step S0704.

If there is an inferior item (YES in Step S0706), then it is judged in Step S0707, whether or not there is a difference, i.e. the inferior item exists in the table of installed feature information of the image forming apparatus 3 but does not exist in that of the image forming apparatus 2 obtained via the server 1. If the inferior item exists only in the table of installed feature information of the image forming apparatus 3 (YES in Step S0707), the table of new feature information is updated with this inferior item in Step S0708, and then the routine goes back to Step S0706 to judge whether or not there is another inferior item. Also if there is no different in Step S0707 (NO in Step S0707), the routine goes back to Step S0706.

If there is no inferior item in Step S0706 (NO in Step S0706), the routine goes back to Step S0704 to judge whether or not there is another mid-level item. If there is no mid-level item (NO in Step S0704), the routine goes back to Step S702.

As described above, the image forming apparatus 3: compares all items of its own sequentially, starting with a superior item, to those in the table of installed feature information of the image forming apparatus 2; detects new feature items existing in the image forming apparatus 3 but not in the image forming apparatus 2; and adds the detected items into the table of new feature information.

If there is no superior item (NO in Step S0702), the table of new feature information having just been made is stored on the memory 23 in Step S0709.

That is all about the mode of implementing the present invention. However, the present invention should not be limited to these modes of embodied implementation described above. For example, when the image forming apparatus 3 obtains my-panel information of the image forming apparatus 2, the display allows users to know if there is a new feature. Similarly, when the image forming apparatus 3 obtains after updating its own features due to a version upgrade or another event, my-panel information created by the image forming apparatus 3 itself before the update, the display may allow users to know if a new feature is installed by the update.

Meanwhile, in these modes of embodied implementation, the image forming apparatus 3 obtains a table of my-panel information and the like of the image forming apparatus 2 via the server 1. Alternatively, the image forming apparatus 3 may obtain them directly from the image forming apparatus 2 via the network or indirectly via a portable recording medium.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming apparatus comprises:
a display portion that displays a key selection screen with one or more than one first operation key to enable a feature of the image forming apparatus, being thereon;
a customization portion that is capable of customizing the key selection screen according to a user operation so that at least one of the first operation keys will not appear thereon;
an information taker that obtains information of a key selection screen customized on a different image forming apparatus or information of another key selection screen previously customized by the customization portion of the image forming apparatus;
a controller that makes the display portion display the customized key selection screen according to the information obtained by the information taker; and
a comparison portion that compares second features currently installed on the image forming apparatus to first features installed on the image forming apparatus originally before the customization or to first features installed on the different image forming apparatus, and
wherein if it is judged based on the comparison results that the second features include one or more than one feature of the print function, not included in the first features, the controller makes the display portion indicate that there is a new feature having been installed on the image forming apparatus while displaying a preview image of print data to be outputted.

2. The image forming apparatus recited in claim 1, wherein the controller makes the display portion indicate that there is a new feature having been installed on the image forming apparatus by displaying at least one second operation key to enable the new feature, while displaying a preview image of print data to be outputted.

3. The image forming apparatus recited in claim 1, wherein the new feature is about picture quality for printing.

4. The image forming apparatus recited in claim 2, wherein when one of the second operation keys is pressed, the controller makes the display portion display a preview image properly reflecting the new feature.

5. The image forming apparatus recited in claim 4, wherein the controller makes the display portion display a preview image properly reflecting the new feature and another preview image not reflecting the new feature at the same time.

6. The image forming apparatus recited in claim 1, wherein the controller makes the display portion indicate that there is a new feature having been installed on the image forming apparatus while displaying the customized key selection screen according to the information obtained by the information taker.

7. The image forming apparatus recited in claim 2, wherein the first operation keys and the second operation keys are laid out in groups depending on the types of the features, on the key selection screens organized in class structure.

8. The image forming apparatus recited in claim 2, wherein when one of the second operation keys is pressed, the customization portion changes the information of the customized key selection screen so that this second operation key will appear thereon.

9. A preview display method for an image forming apparatus, comprising:
customizing a key selection screen with one or more than one operation key to enable a feature of the image forming apparatus, being thereon, according to a user operation, so that at least one of the operation keys will not appear thereon;
obtaining information of a key selection screen customized on a different image forming apparatus or information of another key selection screen previously customized on the image forming apparatus;
making a display portion display the customized key selection screen according to the obtained information; and
comparing second features currently installed on the image forming apparatus to first features installed on the image forming apparatus originally before the customization or to first features installed on the different image forming apparatus, and
wherein if it is judged based on the comparison results that the second features include one or more than one feature of the print function, not included in the first features, the display portion indicates that there is a new feature having been installed on the image forming apparatus while displaying a preview image of print data to be outputted.

10. A non-transitory computer-readable recording medium having a preview display program stored thereon to make a computer execute:
customizing a key selection screen with one or more than one operation key to enable a feature of the image forming apparatus, being thereon, according to a user operation, so that at least one of the operation keys will not appear thereon;
obtaining information of a key selection screen customized on a different image forming apparatus or information of another key selection screen previously customized on the image forming apparatus;
making a display portion display the customized key selection screen according to the obtained information; and
comparing second features currently installed on the image forming apparatus to first features installed on the image forming apparatus originally before the customization or to first features installed on the different image forming apparatus, and
wherein if it is judged based on the comparison results that the second features include one or more than one feature of the print function, not included in the first features, the display portion indicates that there is a new feature having been installed on the image forming apparatus while displaying a preview image of print data to be outputted.

11. The recording medium having a preview display program stored thereon, recited in claim 10, wherein the display portion indicates that that there is a new feature having been installed on the image forming apparatus by displaying at least one second operation key to enable the new feature, while displaying a preview image of print data to be outputted.

12. The recording medium having a preview display program stored thereon, recited in claim 10, wherein the new feature is about picture quality for printing.

13. The recording medium having a preview display program stored thereon, recited in claim 11, wherein when one of the second operation keys is pressed, the display portion displays a preview image properly reflecting the new feature.

14. The recording medium having a preview display program stored thereon, recited in claim 13, wherein the display portion displays a preview image properly reflecting the new feature and another preview image not reflecting the new feature at the same time.

15. The recording medium having a preview display program stored thereon, recited in claim 10, wherein the display portion indicates that there is a new feature having been installed on the image forming apparatus while displaying the customized key selection screen according to the obtained information.

16. The recording medium having a preview display program stored thereon, recited in claim 11, wherein the first operation keys and the second operation keys are laid out in groups depending on the types of the features, on the key selection screens organized in class structure.

17. The recording medium having a preview display program stored thereon, recited in claim 11, wherein when one of the second operation keys is pressed, the information of the customized key selection screen is changed so that this second operation key will appear thereon.
